(19) United States
(12) Patent Application Publication
(10) Pub. No.: US 2024/0333950 A1
(43) Pub. Date: Oct. 3, 2024

(54) EFFICIENT UPSAMPLE METHODS IN NEURAL NETWORK IMAGE COMPRESSION DECODER

(71) Applicant: TENCENT AMERICA LLC, Palo Alto, CA (US)

(72) Inventors: Ding DING, Palo Alto, CA (US); Xiaozhong XU, Palo Alto |, CA (US); Shan Liu, Palo Alto, CA (US)

(21) Appl. No.: 18/616,793

(22) Filed: Mar. 26, 2024

Related U.S. Application Data
(60) Provisional application No. 63/454,821, filed on Mar. 27, 2023.

(51) Int. Cl. H04N 19/44; H04N 19/176; H04N 19/88

(52) U.S. Cl. CPC H04N 19/44; H04N 19/176; H04N 19/88

(57) ABSTRACT

A method and apparatus comprising computer code configured to cause a processor or processors to receive a video bitstream comprising a current block in a current picture and reconstruct the current block by transforming the current block by a neural network comprising a plurality of upsample modules and activation modules, and at least one of the upsample modules includes a convolution layer and a pixel shuffle layer, and at least one of the activation modules includes a LeakyReLu function and a convolution function.

### CROSS-REFERENCE TO RELATED APPLICATION

This application claims priority to U.S. provisional application 63/454,821 filed on Mar. 27, 2023, the disclosure of which is incorporated herein by reference in its entirety.

### TECHNICAL FIELD

This disclosure provides an efficient neural network module for image compression. This architecture can provide reasonable compression performance while substantially reducing the complexity of image compression models.

### BACKGROUND

Recently, ISO/IEC MPEG (JTC 1/SC 29/WG 11) has been actively searching for potential needs for standardization of future video coding technology. ISO/IEC JPEG has established JPEG-AI group focusing on AI-based end-to-end neural image compression using Deep Neural Networks (DNN). The Chinese AVS standard has also formed AVS-AI special group to work on neural image and video compression technologies. At the meantime, companies have also funded specialized research projects for NIC. The success of recent approaches has brought more and more industrial interests in advanced neural image and video compression methodologies.

A traditional hybrid video codec is difficult to be optimized. An improvement of a single module may not result in a coding gain in overall performance. In contrast, in an artificial neural network-based video/image coding framework, by performing a machine learning process, different modules can be jointly optimized from input to output to improve a final objective (e.g., rate-distortion performance), resulting in an end-to-end (E2E) optimized Neural Image Compression (NIC).

And for any of those reasons there is therefore a desire for technical solutions to such problems that arose in computer technology.

### SUMMARY

According to an aspect of the disclosure, there is an apparatus, and similarly a method and computer readable medium, including at least one memory configured to store computer program code; and at least one processor configured to access the computer program code and operate as instructed by the computer program code, the computer program code including: receiving code configured to cause the at least one processor to receive a video bitstream comprising a current block in a current picture; and reconstructing code configured to cause the at least one processor to reconstruct the current block by transforming the current block by a neural network comprising a plurality of upsample modules and activation modules, and at least one of the upsample modules includes a convolution layer and a pixel shuffle layer; and at least one of the activation modules comprises a LeakyReLu function and a convolution function.

The at least one of the upsample modules may include just the convolution layer and the pixel shuffle layer.

The at least one of the activation modules may include a plurality of the LeakyReLu functions such that an output of the LeakyRelu function may be output to the convolution function and an output of the convolution function may be output to a second LeakyReLu function of the plurality of LeakyReLu functions.

An output of the LeakyRelu function may be output to the convolution function and an output of the convolution function may be output to a multiplication function.

An output of the multiplication function may be output to an addition function.

An output of the LeakyRelu function may be output to the convolution function and an output of the convolution function may be output to an addition function.

The convolution function may include a 1×1 filter.

Each of the plurality of upsample modules may include respectively different numbers of kilo multiply and accumulate (KMAC) operations.

One of the plurality of upsample modules may include more than double a number of KMAC operations than does any of the other of the plurality of upsample modules.

The plurality of upsample modules may be just four upsample modules.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other features and aspects of embodiments of the disclosure will be apparent from the following description taken in conjunction with the accompanying drawings, in which:

FIG. 1 is a schematic illustration of a diagram in accordance with embodiments;

FIG. 2 is a simplified flow diagram in accordance with embodiments;

FIG. 3 is a simplified diagram in accordance with embodiments;

FIG. 4 is a simplified flow diagram in accordance with embodiments;

FIG. 5 is a simplified diagram in accordance with embodiments;

FIG. 6 is a simplified diagram in accordance with embodiments;

FIG. 7 is a simplified diagram in accordance with embodiments;

FIG. 8 is a simplified diagram in accordance with embodiments;

FIG. 9 is a simplified diagram in accordance with embodiments;

FIG. 10 is a simplified diagram in accordance with embodiments;

FIG. 11 is a simplified diagram in accordance with embodiments;

FIG. 12 is a simplified diagram in accordance with embodiments;

FIG. 13 is a simplified diagram in accordance with embodiments;

FIG. 14 is a simplified diagram in accordance with embodiments;

FIG. 15 is a simplified diagram in accordance with embodiments;

FIG. 16 is a simplified flow diagram in accordance with embodiments;

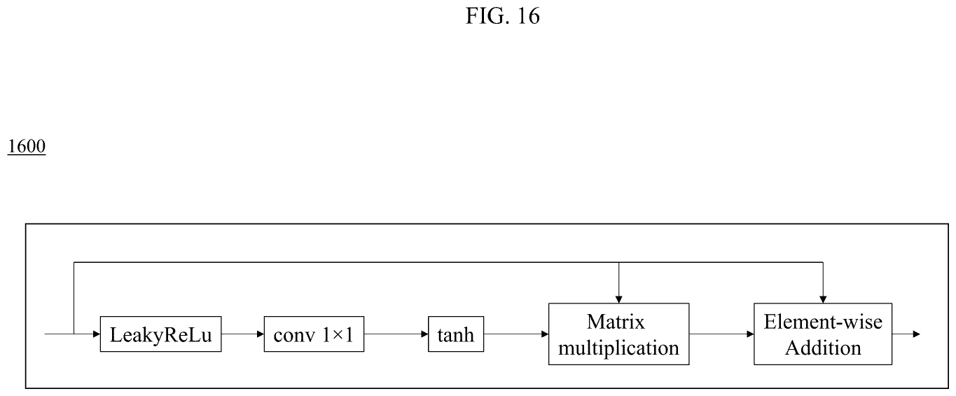

FIG. 17 is a simplified diagram in accordance with embodiments;

FIG. 18 is a simplified diagram in accordance with embodiments;

FIG. 19 is an illustration in accordance with embodiments;

FIG. 20 is a simplified diagram in accordance with embodiments;

FIG. 21 is a simplified diagram in accordance with embodiments;

FIG. 22 is a simplified diagram in accordance with embodiments;

FIG. 23 is a simplified diagram in accordance with embodiments; and

FIG. 24 is a simplified diagram in accordance with embodiments.

### DETAILED DESCRIPTION

The following detailed description of example embodiments refers to the accompanying drawings. The same reference numbers in different drawings may identify the same or similar elements.

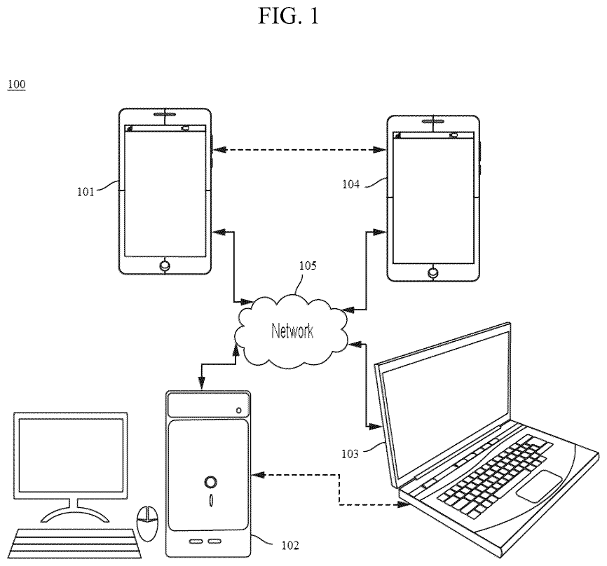

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

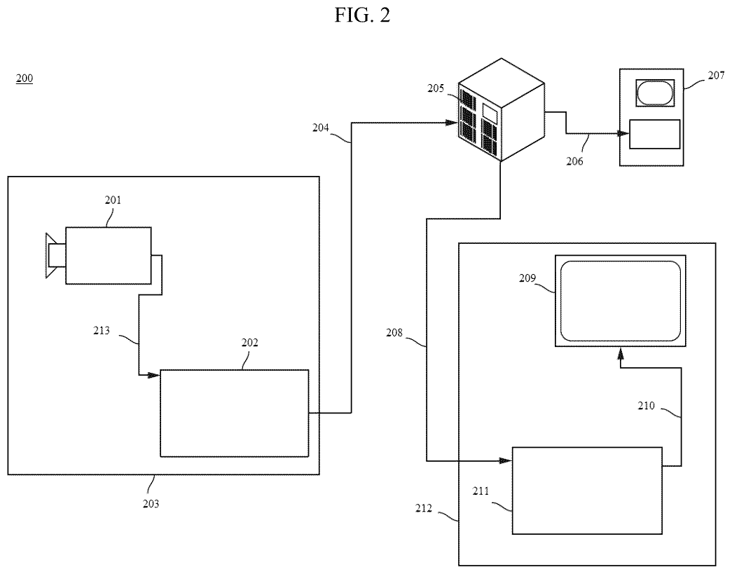

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the camera 201. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein.

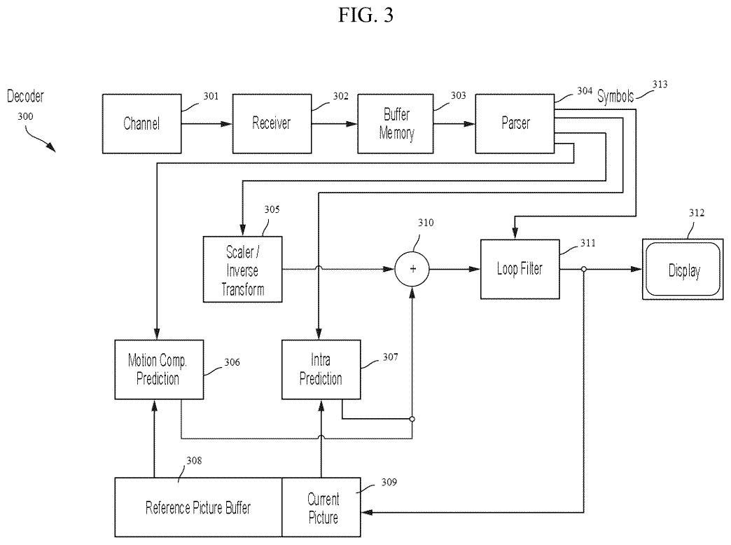

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder/parser 304 (“parser” henceforth). When receiver 302 is receiving data from a store/forward device of sufficient bandwidth and controllability, or from an isosychronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information parameter set fragments (not depicted). The parser 304 may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser 304 may perform entropy decoding/parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler/inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit 305. The scaler/inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler/inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler/inverse transform unit 305.

In other cases, the output samples of the scaler/inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the render device 312 as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

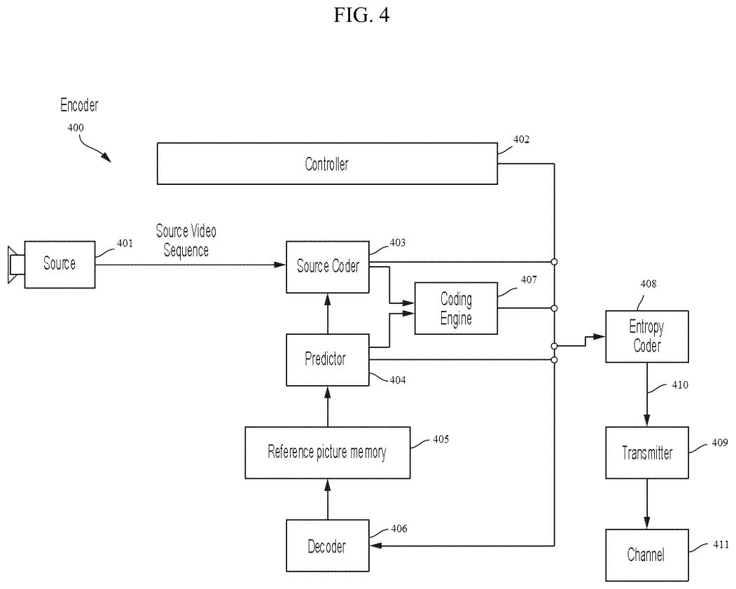

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder 402 (“source coder” henceforth) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder (not shown in FIG. 4), the reconstructed video sequence typically may be a replica of the source video sequence with some errors. The local video decoder 406 replicates decoding processes that may be performed by the video decoder on reference frames and may cause reconstructed reference frames to be stored in the reference picture cache 405. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the video coder 403, including, for example, setting of parameters and subgroup parameters used for encoding the video data.

Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the video coder 403 with other data to be transmitted, for example, coded audio data and/or ancillary data streams (sources not shown).

The controller 402 may manage operation of the encoder 400. During coding, the controller 405 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder 400 may perform coding operations according to a predetermined video coding technology or standard, such as ITU-T Rec. H.265. In its operation, the video coder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

According to embodiments, a general framework of NIC is described as follows: given an input image x, the target of NIC is to use the image x as the input to a DNN encoder to compute a compressed representation \hat{x} that is compact for storage and transmission purposes. And then, use \hat{x} as the input to a DNN decoder to reconstruct an image x̅. Other NIC methods take a variational autoencoder (VAE) structure, where the DNN encoders directly use the entire image x as its input, which is passed through a set of network layers that work like a black box to compute the output representation \hat{x}. Correspondingly, the DNN decoders take the entire representation x as its input, which is passed through another set of network layers that work like another black box to compute the reconstructed x̅. A Rate-Distortion (R-D) loss is optimized to achieve trade-off between the distortion loss (x, x̅) of the reconstructed image and the bit consumption R of the compact representation \hat{x} with a trade-off hyperparameter λ:

$$L ( x , \overline{x} , \hat{x} ) = λ D ( x , \overline{x} ) + R ( \hat{x} ) \qquad Eq . ( 1 )$$

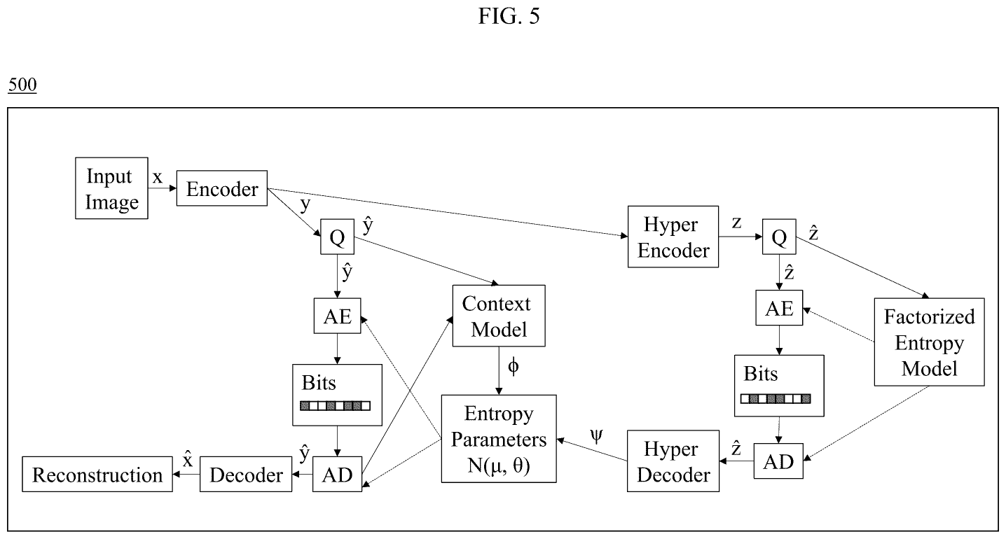

FIG. 5 shows a general architecture 500 of NIC according to exemplary embodiments. The encoder includes a set of vision module (such as convolutional network, or vision transformer) with downsample function; while the decoder consists a set of vision module (such as convolutional network, or vision transformer) with upsample function.

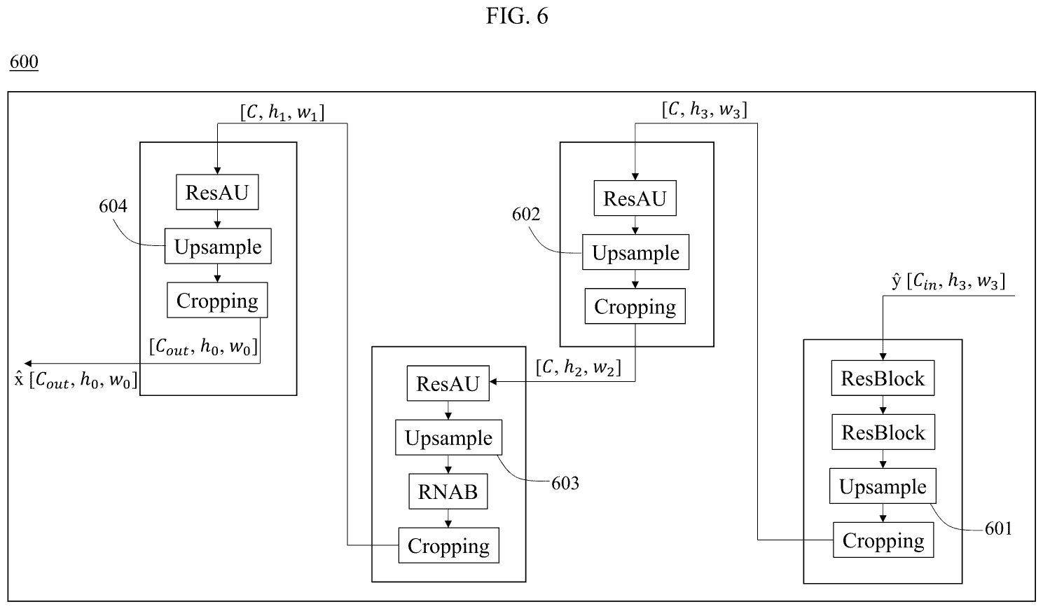

FIG. 6 shows an example 600 of detailed structure of a decoder according to exemplary embodiments. The resblock in the front of upsample block 601 can be removed in some embodiments. ResAU is the activation function. RNAB is the attention module. In one embodiment RNAB consists of a set of resblocks. In another embodiment, RNAB is the transformer-based attention. According to exemplary embodiments, this efficient neural network structure comprises improved upsample blocks 601, 602, 603, 604 in decoders.

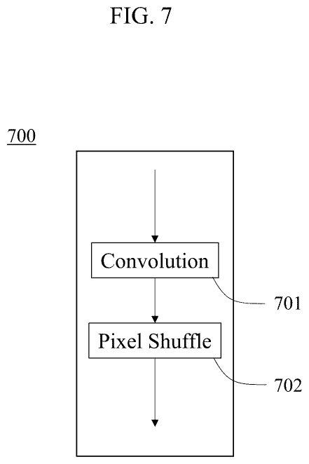

A key aspect of embodiments includes an efficient tensor transform with upsample module in decoders. FIG. 7 shows an example of a detailed upsample module 700, such as any of the upsample blocks 601, 602, 603, and 604.

The upsample module 700 consists of a convolution layer 701 and a pixel shuffle layer 702. Convolution layer 701 is used for increasing the number of channels of input tensor, while the pixel shuffle layer 702 is to upsample the tensor.

Embodiments do not necessarily constrain the details of the convolution layer 701. In one embodiment convolutional net has 3×3 filter size; in another preferred embodiment, convolutional network has 5×5 filter size; in another preferred embodiment, convolutional net has 7×7 filter size. In another embodiment, the upsample module is traditional transpose convolution network.

According to embodiments, such as with FIG. 6, there may be four upsample modules, such as the upsample blocks 601, 602, 603, and 604, in the decoder. In one embodiment, four upsample modules are same (i.e., they all pixel shuffle with 1×1 convolution.)

In one embodiment, the upsample modules are different. In one embodiment, first upsample module, upsample block 601, is transpose convolution with filter size 3×3. Second upsample module, upsample block 602, is transpose convolution with filter size 3×3. Third upsample module, upsample block 603, is pixelshuffle with convolution 1×1. Fourth upsample module, upsample block 603, is pixelshuffle with convolution 1×1. These upsample modules can be any combination.

Comparing with traditional modules in the neural image compression (comparative examples described hereinafter) such exemplary embodiments have reached advantageous and reasonable compression rates while substantially reducing the complexity of image compression models.

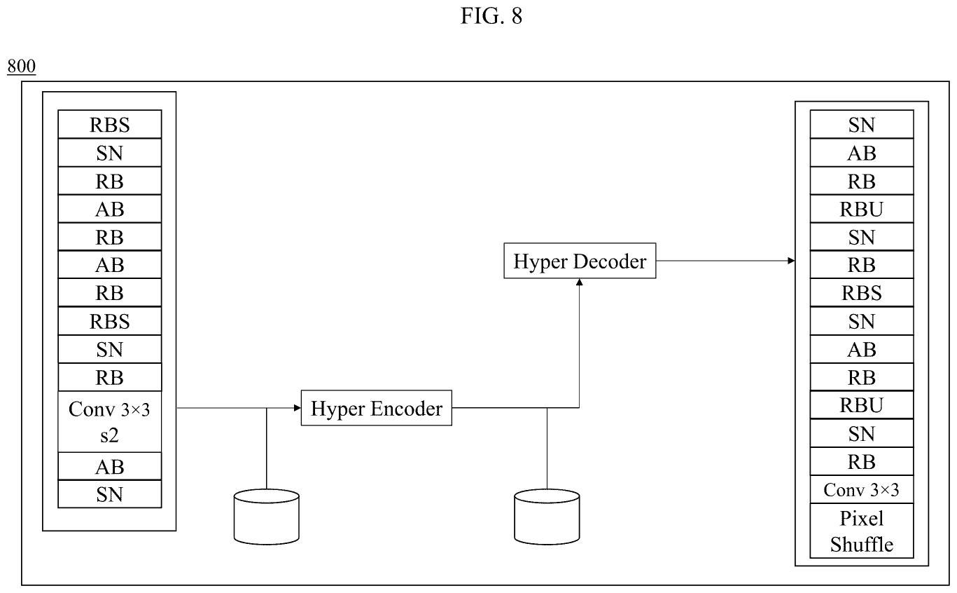

FIG. 8 shows the core network structure 800 of a solution for the JPEG AI call for proposal as a simplified analysis and synthesis transform which may be used in VMuC to achieve the better performance/complexity tradeoff.

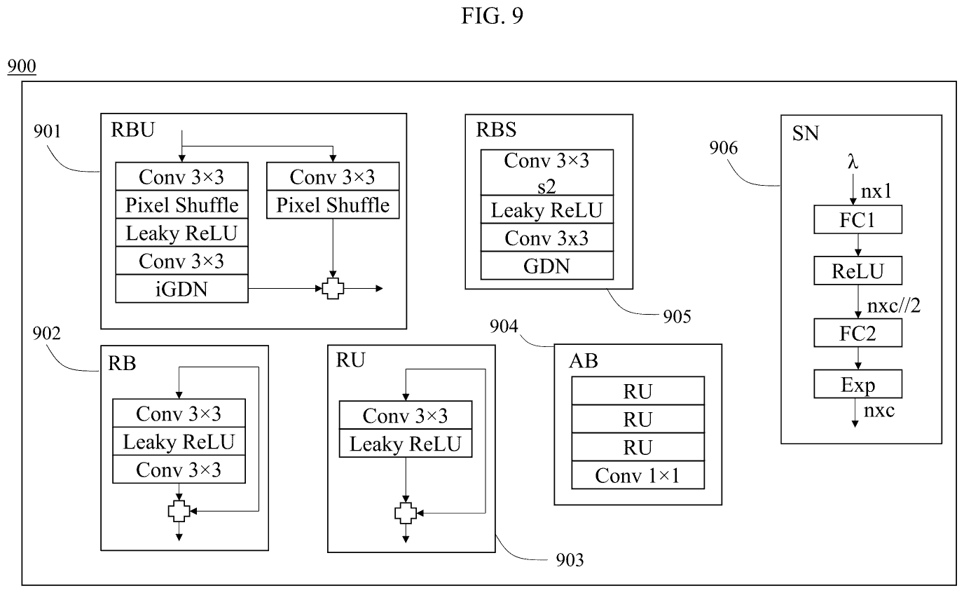

FIG. 9 shows the modules (module 901 being a Res Block with Upsample (RBU)), module 902 being a Res Bloc (RB), module 903 being a Res Unit (RU), module 904 being an attention block (AB), module 905 being a Res Block with Stride (RBS), and module 906 being a scaling net (SN)) used in analysis and synthesis transforms according to exemplary embodiments. ResBlock with Stride (RBS) is the downsample module in the analysis transform; while ResBlock with upsample (RBU) are used as the upsample module in synthesis transform according to embodiments.

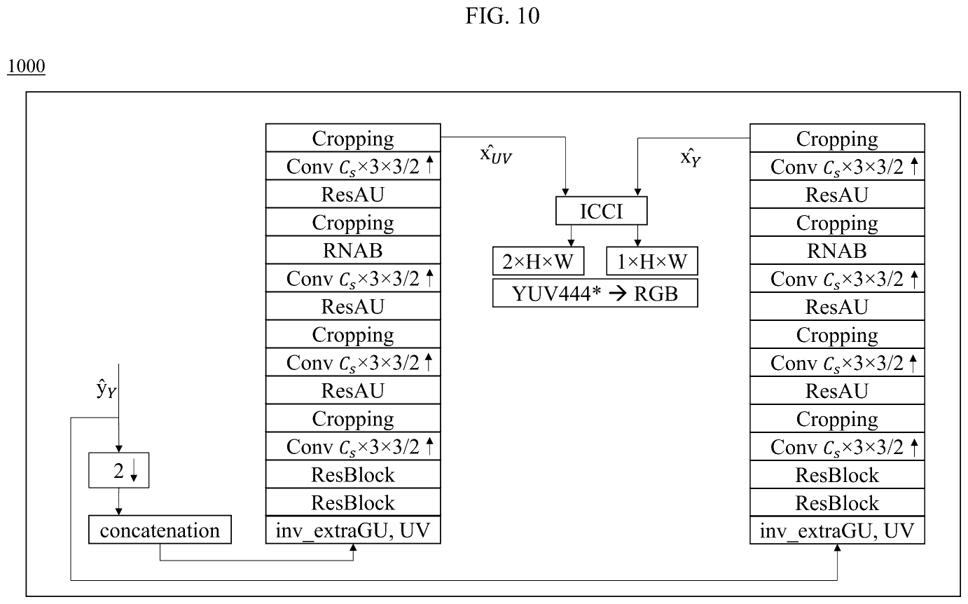

FIG. 10 shows a synthesis transform of VMuC according to exemplary embodiments and, as in FIG. 10, contains upsampling module (convolutional network and ResAU) and Resblocks.

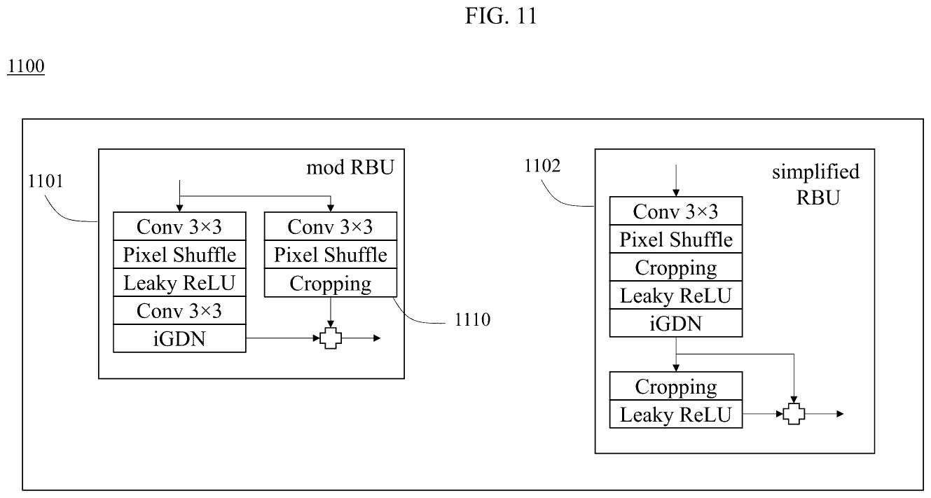

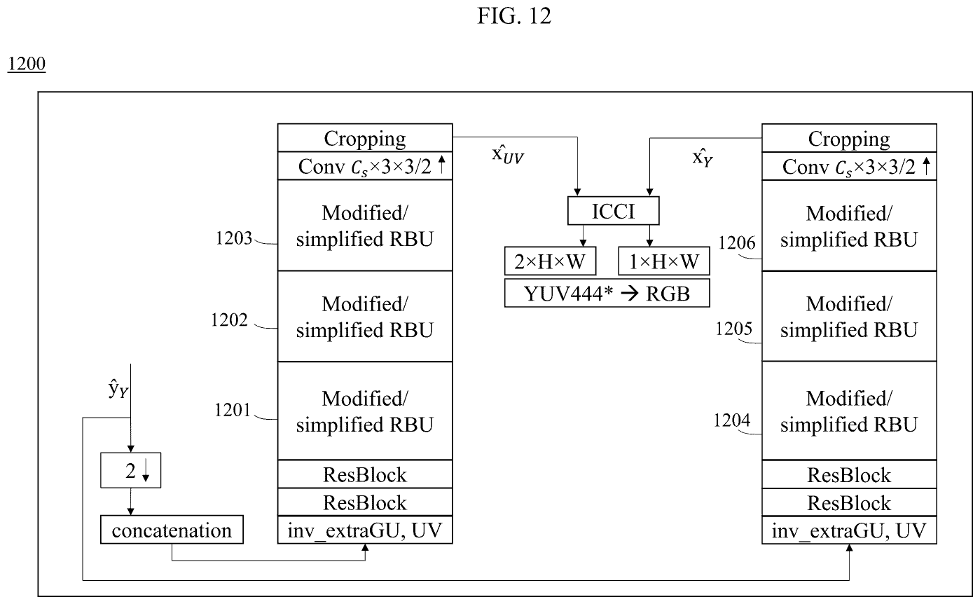

Comparative tests were implemented in which “TEST 01” used modified RBU (instead of conv and ResAU) in the VM and also removed the RNAB module, “TEST 02” used simplified RBU (instead of conv and ResAU) in a latest VM, and removed RNAB module, and “TEST 03” used modified RBU (instead of conv and ResAU) in the VM, and kept the RNAB module. The details of the modified RBU module 1101, according to exemplary embodiments, are shown in the example, with added cropping module 1110, of FIG. 11. The details of the simplified RBU module 1102, according to exemplary embodiments, are shown in the example of FIG. 11. And an example in which any of the simplified RBU module 1102 and the the modified RBU module 1101 are added to any of the modified/simplified RBU module blocks 1201, 1202, 1203, 1204, 1205, 1206 shown in the example 1200 of FIG. 12.

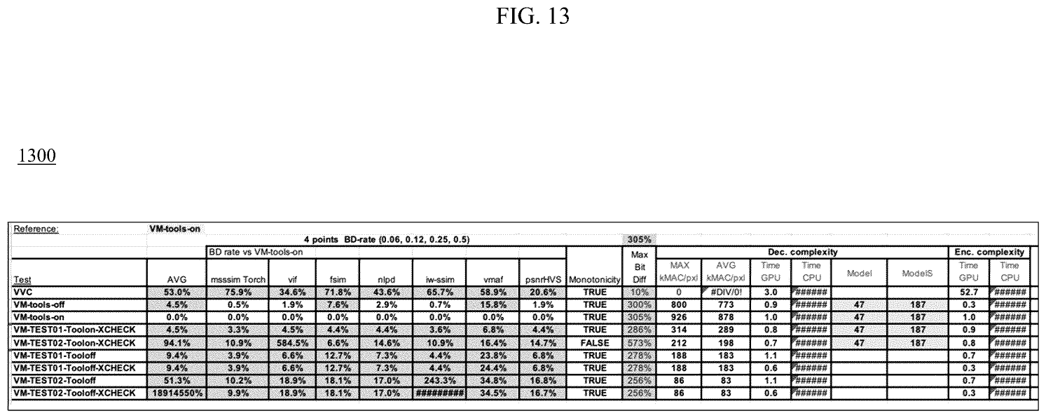

The comparative example 1300 of FIG. 13 for Test 01 and Test 02 are shown in FIG. 13.

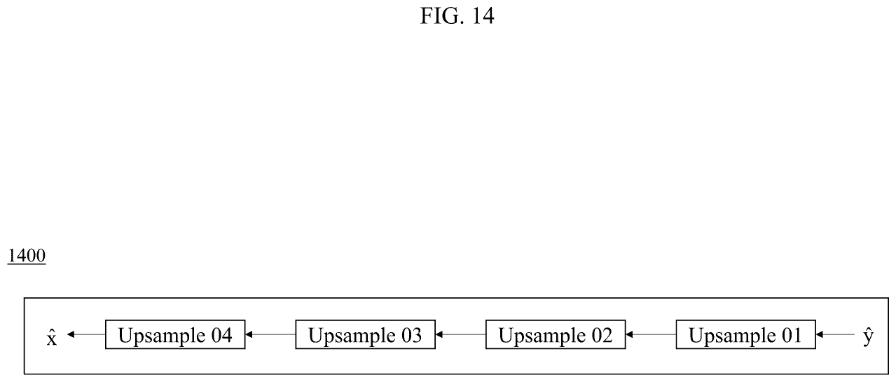

The example 1400 of FIG. 14 illustrates a VM upsample structure according to exemplary embodiments in which a transform consists of four transpose convolution layers. Among them, the upsample 03 module has a largest number of KMACs. The brief kmacs for each upsample module. Upsample 01: ˜5, Upsample 02: ˜15, Upsample 03: ˜60, and Upsample 04: ˜2 according to exemplary embodiments.

With the embodiments of FIG. 14, a goal was, as compared with other embodiments, to replace the transpose conv with pixelshuffle with regular convolution network. And as such, a convolution network with 1×1 filter before the pixelshuffle to change the number of channels was used. And, by testing, conv net with 3×3 filter does not provide significant gain comparing with conv net with 1×1 filter, but also did introduce many of KMACs. So, as a technical solution, embodiments herein may replace transpose conv with pixelshuffle and regular convolution network with 1×1 filter.

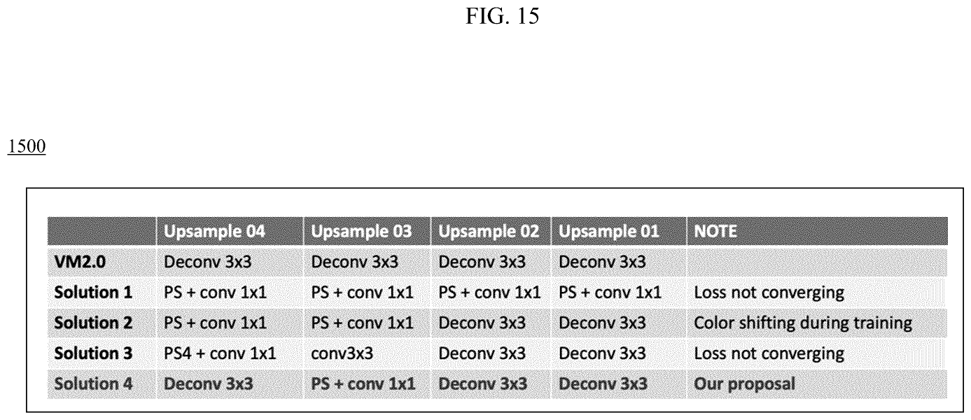

The example table 1500 of FIG. 15 illustrates simplified upsample implemented according to exemplary embodiments herein. By testing, training in Solution 1 and Solution 3 were found to be hard to get loss converged. And Solution 2 was found to have some color shifting issue during the training. So, the solution 4 may be implemented as a simplified upsample solution according to exemplary embodiments. Compared with Anchor, the simplified upsample reduces 39 kMac/pxl (around 43% reduction if we do not consider RNAB module), and introduce only 0.2% coding loss.

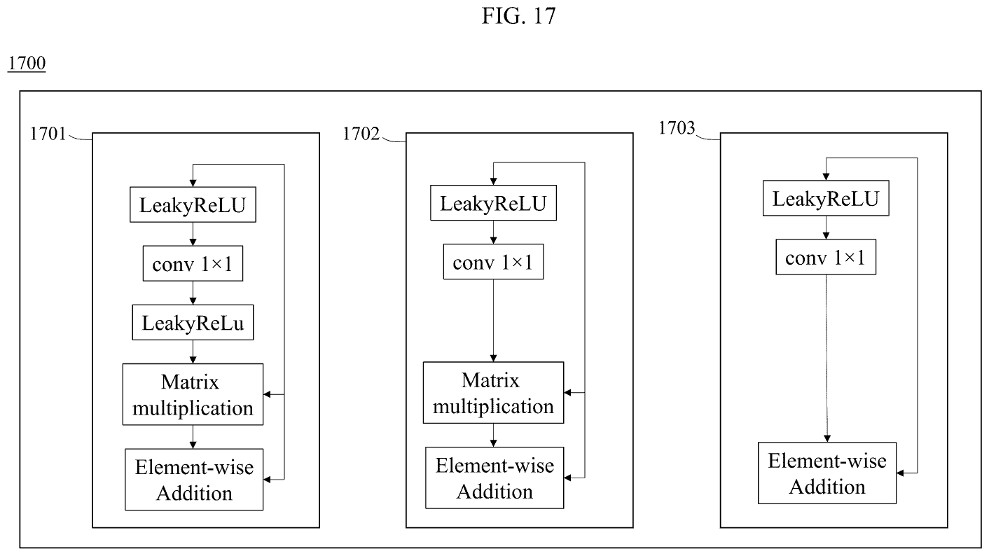

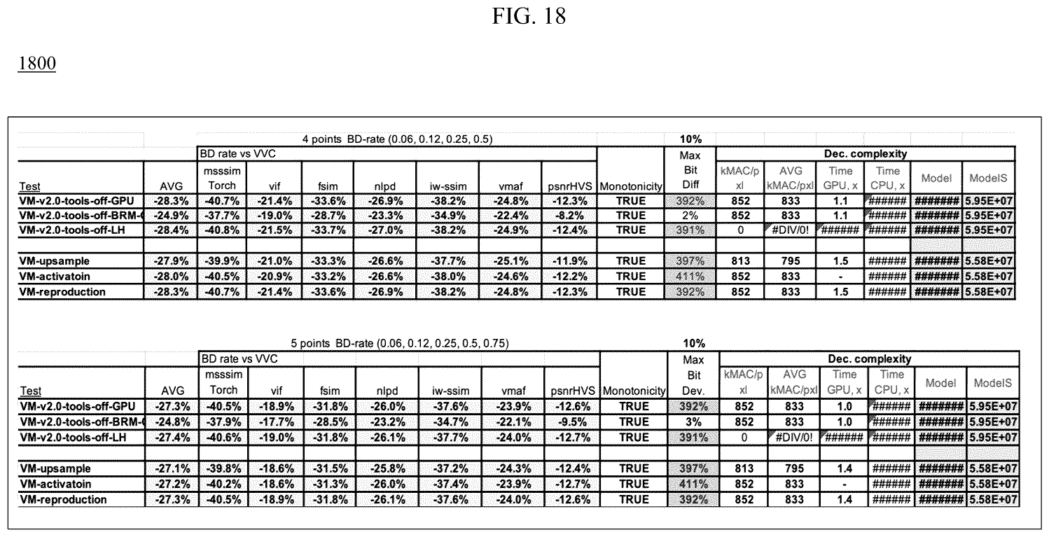

In light of FIG. 15, the example 1600 of FIG. 1600 illustrates an activation function implemented according to exemplary embodiments herein, and of which three simplified activation function architectures (a solution 1 embodiment 1701 in which tan h may be replaced with LeakyReLU, a solution 2 embodiment 1702 in which tan h may be removed, and a solution 3 embodiment 1703 in which the tan h and multiplication may be removed) thereof are illustrated in FIG. 17, and by testing, solution 3, the embodiment 1703, has shown best performance and complexity tradeoff as illustrated in test results 1800 of FIG. 18.

Learning-based image coding schemes, exemplified by JPEG AI, have shown potential by greatly exceeding the conventional image compression standards in rate-distortion (RD) performance. However, their widespread applications are hindered by high decoding complexity, particularly from the upsampling and attention modules. Existing works sought to reduce this complexity, but their solutions are not fully effective, leaving considerable complexity unaddressed. As such, embodiments herein present a simplified transform network architecture that employ an optimized attention module, a streamlined upsampling module, and a pared-down activation function to tackle this issue. Simulation results show that the simplified decoder sees its complexity (measured by kMACs/pixel) reduced by 80% (from 833 to 172), while the gain over Versatile Video Coding (VVC) increases slightly (from 27.3% to 27.5%). Partial methods described herein may be integrated into the JPEG AI Verification Model (VM) software.

Machine learning has brought breakthroughs in various fields, particularly in neural network-based image compression JPEG AI, a standard developed by JPEG, represents a significant stride in this field. It is designed for human visualization and computer vision tasks.

Despite these advancements, one of the major challenges with JPEG AI's verification model (referred to as JPEG AI VM) is its high complexity, particularly with its transform network in the decoder. This complexity can result in higher computational costs, reducing the practicability and efficiency of the standard. While there exist several works on reducing the complexity of the decoder, e.g., simplifying the context model entropy decoding process and exploring the sparse network structure technique limited attention is paid to design a transform network architecture in the decoder and most existing schemes brings performance degradation.

As such, embodiments herein address this challenge by providing three simplifications to the transformer network: 1) a revised attention module, 2) a new upsampling module, and 3) a simplified activation function. These modifications reduce computational load and improve efficiency without compromising the system's performance. Specifically, there is introduced a transformer-based attention module with a hierarchical architecture to reduce complexity. Embodiments adopt a Restormer block, applying self-attention across channels rather than the spatial dimension, effectively capturing global information, and reducing complexity. There is also employed a Pixel Shuffle operation with a preceding 1×1 convolution as an upsampling scheme. Such a design reduces computational complexity while maintaining network performance. And also, there is provided a more streamlined activation function without the hyperbolic tangent and subsequent element-wise operation to further reduce computational complexity.

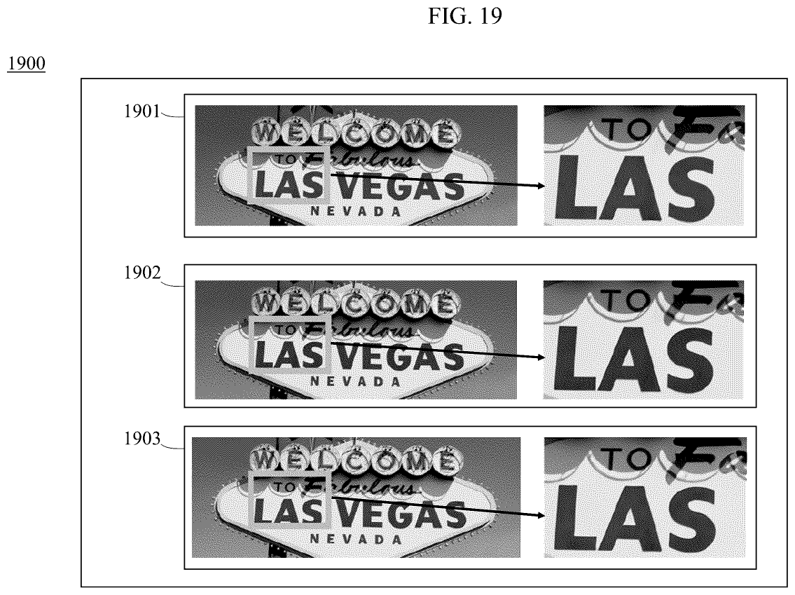

FIG. 19 provides a comparative analysis of the details in the reconstructed images. The top panel 1901 depicts the original, uncompressed image, the middle panel 1902 illustrates the reconstruction post-compression via JPEG AI VM, and the lower panel 1903 displays the reconstruction achieved through a scheme based on JPEG AI according to embodiments herein. The visual comparison demonstrates the ability of embodiments herein to reduce KMACs (kilo multiply-accumulate operations) while decreasing the bits per pixel (bpp) and enhancing image quality.

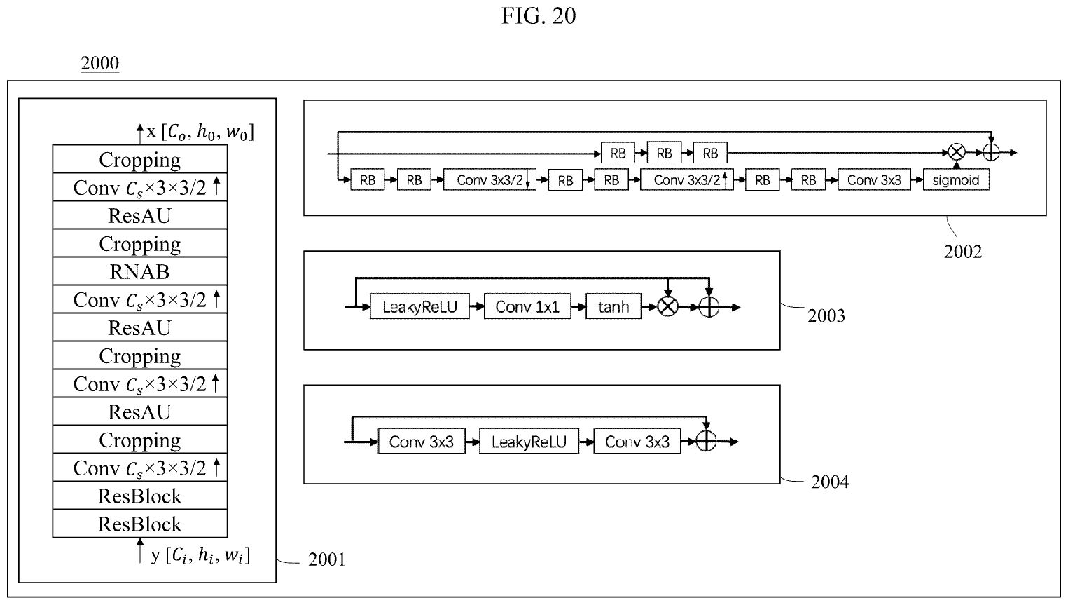

The structure of the JPEG AI transform network 2001 is depicted in example 200 of FIG. 20. Embodiments focus on the decoder transformer network as it is crucial for decoding complexity. It has two residual blocks (RBs) placed at the beginning of the net and the sequence of 4 convolutions with up-sampling stride 2 to increase the resolution of the output. Also, it has a residual attention unit (ResAU) as the activation function and a residual nonlocal attention module (RNAB) as the attention module to improve the non-linear representation ability. The architecture of RNAB 2002, ResAU 2003, and RB 2004 are shown in FIG. 20. Embodiments focus on the decoder transformer network as it is crucial for decoding complexity. As seen, the JPEG AI transform network 2001 has two RBs placed at the beginning of the net and the sequence of 4 convolutions with up-sampling stride 2 to increase the resolution of the output. Also, it has a ResAU as the activation function and a RNAB as the attention module to improve the non-linear representation ability.

While JPEG AI achieves promising performance, it also brings intensive computational complexity for the transform network decoder side. Specifically, the current transform network at the decoder side has 833 kMACs/pixel complexity, which is computationally expensive. Specifically, among all the components, the RNAB and upsampling module have the highest and second highest complexity, accounting for 95% of the complexity together. To this end, embodiments include two low complexity transformer-based attention and pixel shuffle-based up-sampling modules to replace the current RNAB and upsampling modules to reduce the complexity while maintaining comparable performance.

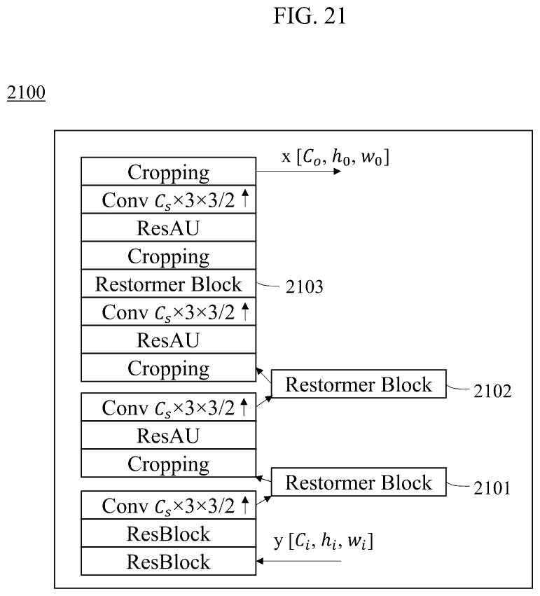

As shown in the example 2100 of FIG. 21, embodiments provide a transformer-based attention module to capture the global information to maintain the performance and hierarchical attention architecture to achieve low complexity. The architecture 2100 is shown in FIG. 21.

The transformer architecture 2100 according to embodiments has demonstrated its advantage over convolution in various vision tasks due to the capability of capturing global information. However, the memory usage of the original vision transformer is quite large, especially for high-resolution images. Second, the complexity grows quadratically with the input width/height), resulting in high kMACs/pixel. While some adopts Swin Transformer introducing shifted window-based attention to reduce the complexity. However, it cannot capture the information over long distances for high-resolution images and could result in performance degradation.

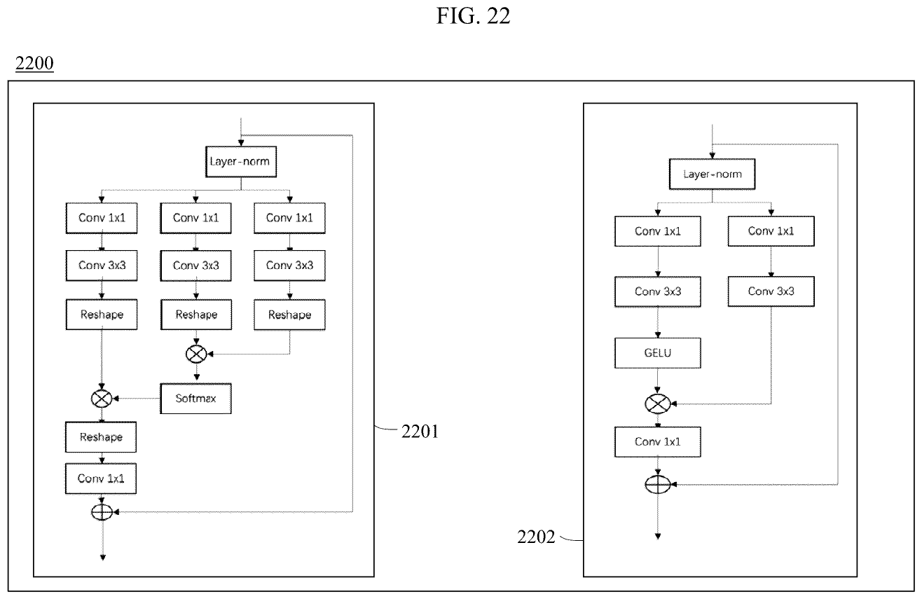

To tackle the above two challenges, embodiments adopt the Restormer block (e.g., Restormer block 2101, Restormer block 2102, Restormer block 2013) as the basic module in such embodiments herein. Restormer block applies self-attention across channels rather than the spatial dimension, i.e., the time and memory complexity of the keyquery dot-product grows linearly with the spatial resolution of the input. The detailed structure of Restormer block is depicted on FIG. 22, consisting of two sub-blocks:

There is a Multi-Dconv Head Transposed Attention (MDTA) Block 2201. This block is applied to generate the global attention map. Suppose the input is X. Embodiments first pass X into a layer-norm operator and obtain the normalized value. After that, the query (Q), key (K) and value (V) are obtained with the normalized value using three groups of 1×1 convolution and 3×3 depth-wise convolutions, respectively. Such a process can encode channel-wise spatial context. Finally, we can obtain the transposed-attention map by calculating the dot-product of the reshaped query and key.

Gated-Dconv Feed-Forward Network (GDFN) Block 2202. GDFN expands the feature channels, making it identical to the input dimension. Overall, the Restormer block will first pass the input into MDTA to capture the features with contextual information and then feed the intermediate result into the GDFN to control the information flow. Embodiments also design the following two approaches to optimize the peak-memory usage:

There is also a Channel-splitting. That is, after the third convolution, there is illustrated a splitting of the output into two parts across the channel and pass them into two Restormer blocks, respectively.

There is also a Spatial-down-sampling. Suppose the output after the third convolution is X∈ [symbol] ^{C×H×W}. Embodiments may first downscale the X before passing it into the transformer block, i.e., the shape of the intermediate output is C×(H/2)×(W/2). After that, embodiments upscale the output to maintain the resolution unchanged.

There is also a Low-complexity Upsampling Module As depicted in the JPEG AI transform network 2001 in FIG. 20, the decoder structure consists of four upsampling modules. JPEG AI VM2.0 employs transpose convolution with a stride of 2 for the upsampling process, wherein the kernel size is set as 3. This approach is noted for its high coding complexity. A closer look at the specifics of the upsampling modules in VM2.0 reveals a gradual increase in complexity from right to left. The computational costs (measured in KMACs/pixel) associated with the four upsampling modules are as follows: 5, 15, 60, and 2, respectively. This increasing trend in complexity corresponds with the growing size of the feature map as it passes through these modules. This relationship culminates in the third upsampling module, which presents the highest complexity due to the increased feature map size. Interestingly, despite the last upsampling module having the largest input size, it exhibits a relatively lower computational cost. This reduction is attributed to the module only outputting three layers, limiting its overall complexity.

The Pixel Shuffle operation, in essence, rearranges elements in a tensor so that the spatial resolution (height and width) of the tensor increases while the depth (or the number of channels) decreases. Given an input feature map F with channels C=n*r2 and a spatial resolution of H×W, Pixel Shuffle reorganizes the elements of F to form a new feature map F″ with depth (or channels) C=n, but a spatial resolution of rH×rW. Here, r is an integer upsampling factor.

Indeed, the Pixel Shuffle operation is typically preceded by a standard convolution operation to increase the number of channels in the input tensor. This allows the Pixel Shuffle operation to redistribute the pixels appropriately to achieve the desired upsampling effect. When the filter size is 1×1, compared with transpose convolution with 3×3 filter, the complexity of this upsampling module (both convolution layer with filter 1×1 and pixel shuffle) decreases. By replacing the third upsampling module from the right, which has the highest computational cost in terms of KMACs/pixel, we can substantially reduce the complexity of the decoder.

There is also a Low-complexity Activation Function Module according to embodiments herein. There is an activation function module including an assembly of several sub-modules, including a LeakyReLU, a 1×1 convolution layer, and a hyperbolic tangent. Additionally, it involves some complex operations, such as element-wise multiplication. The complete module structure is displayed in ResAU 2003 in FIG. 20. While many of these operations are seen as essential components in a neural network, embodiments herein are based on identification of certain redundancies that, despite not being explicitly quantifiable in terms of KMACs/pixel, do add unnecessary complexity to the system. As such, embodiments have included a simplified model that streamlines the structure of the activation function module. Specifically, there is herein a removal of the hyperbolic tangent activation function and the subsequent element-wise operation according to embodiments.

Embodiments herein have been compared with the JPEG AI common training and test condition defined in on Nvidia A100 GPU devices. The 0.06, 0.12, 0.25, 0.50, and 0.75 bitrates are mandatory and were used for BD rate computation. Objective quality metrics include MS-SSIM, FSIM, NLPD, IWSSIM, VMAF, VIF and PSNR-HVS-M, between compressed and original image, at these target bitrates. The average Bjøntegaard Delta-rate (BD-rate) rate across the seven aforementioned metrics (MS-SSIM, FSIM, NLPD, IW-SSIM, VMAF, VIFP, and PSNR-HVS-M) as our primary distortion metrics were used to gauge the quality of the image compression. These seven metrics collectively provided a comprehensive and accurate image quality assessment, considering various aspects of perceptual similarity, naturalness, and fidelity. To measure the complexity of the model, the widely-used ptflops library was adopted to compute the kMACs/pixel. This allows us to gauge the computational efficiency of our algorithm.

Embodiments primarily present and evaluate simplified alternatives to specific JPEG AI VM 2.0 components, which serves as our benchmark. In Section IV-B, embodiments evaluate the multi-level attention architecture with two variations channel-splitting and spatial-down-sampling strategies, respectively. Descriptions below provide results of an investigation of the effects of a simplified upsampling module, a simplified activation function, further reducing complexity, and a combination test amalgamating all the proposed simplifications into a single model, for evaluation.

Embodiments were evaluation by comparing the simplified attention modules with channel-splitting (Attention-CS) and spatial-down-sampling (Attention-DS) after the third convolution layer to optimize peak-memory usage. For Simplified Attention Modules-CS, γ was set to 2.66 for the Restormer blocks after all convolution layers, respectively. For Simplified Attention Modules-DS, γs was set to 4, 4, and 2.66 for the Restormer blocks after the first, second, and third convolution layers, respectively.

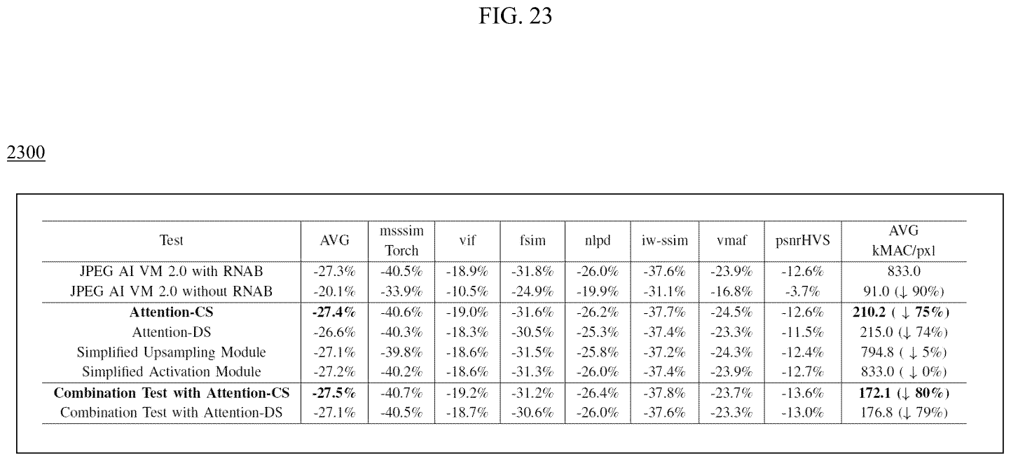

Results of such experiments are shown in the example table 2300 in FIG. 23 and have the following observations. First, Attention-CS and Simplified Attention Modules-DS can reduce decoding complexity (up to 75%), while the performance drop is minor (up to 0.8%). This demonstrates the usefulness of the proposed multi-level transformer-based attention architecture. Second, Attention-CS outperforms Attention-DS on both BD rate and decoding complexity. The reason might be that the resolution after the third convolution is high, and the spatial information is more critical than the channel-wise information for the final performance. This indicates that the channel-splitting approach is more desirable for the JPEG AI codec.

In the table 2300, the negative values mean coding performance (lower is better), and for the same initialized two trained models, the performance deviates up to 0.5%, caused by the randomness introduced in training, and the computations within the activation function is not explicitly quantifiable in terms of kMACs/pixel.

Embodiments may also replace the third upsampling module from the right with our proposed simplified upsampling method. Specifically, compared with the original upsampling module (Anchor-in VVC), this simplified upsampling approach reduces 39 kMACs per pixel. Suppose embodiments disregard the RNAB (Residual Non-local Attention Blocks) module, in that case, this reduction equate to approximately 43% of the computational cost.

When examining the overall effect of the simplified upsampling module, we observe an average BD rate decrease of 0.2%. Considering the nature of deep learning models, especially when focusing on complex tasks such as JPEG AI, there is an inherent uncertainty associated with each training iteration. This uncertainty, or training error, typically varies around 0.5% for each JPEG AI training cycle. Thus, when we place the 0.2% decrease in the BD rate within this context, it falls well within the typical training error range. This leads to an important conclusion: The minor loss incurred by implementing the simplified upsampling module can be considered negligible. Overall, our proposed simplified upsampling approach provides substantial computational savings without compromising the model's rate-distortion efficiency.

By introducing a simplified activation function in the transform network, as depicted in example table 2300, there was observed a coding gain loss of approximately 0.1%. This seemingly minor loss, given the inherent variability in the training process, and can essentially be dismissed as negligible. It falls well within the bounds of the expected training error and does not affect the overall performance of the model according to the example embodiments herein.

By such experimenting, it was noted that the complexity of the complicated activation function is not explicitly quantifiable in terms of KMACs/pixel by ptflops. However, it incurs unnecessary complexity to the system, and therefore, such redundancies can be removed by the simplified scheme of embodiments herein.

Also, there was conducted a combination test to assess the general applicability of each simplified method (simplified attention, upsampling, and activation) according to embodiments herein. The results, also presented in the example table 2300 of FIG. 23, demonstrate that the simplified modules herein have remarkable robustness and effectiveness. The computational complexity regarding kMACs/pixel was reduced from 833 to 172.1. Moreover, embodiments herein managed to achieve a coding gain of 0.2%.

The observations underscore the value of these simplifications. Each contributes to a more computationally efficient model without degrading the overall performance. Furthermore, the combination tests reaffirmed the robustness of these simplified methods with other modules, reinforcing their broad applicability and effectiveness in various scenarios.

As such, embodiments herein have addressed the high decoding complexity inherent in learning-based image coding schemes, which, despite their superior rate-distortion performance, have seen limited practical applications due to high complexity. Specifically, there is proposed a series of modifications to the decoder architecture of the JPEG AI standard, namely, the simplification of the attention module, the upsampling module, and the activation function. The revised attention module leverages a low-complexity hierarchical attention structure, utilizing a transformer-based module to capture better global information and a novel memory-optimized strategy to ensure feasible memory usage. The upsampling module incorporates the pixel shuffle technique to mitigate complexity without jeopardizing network stability. The activation function has been streamlined by removing extraneous operations and retaining only the essential components, further reducing complexity.

The modifications according to embodiments herein reduced computational complexity, with the kMACs/pixel metric decreasing from 852 to 180. Importantly, this improvement in computational efficiency also brings a slight increase in gain over VVC, from 27.3% to 27.5%. Such findings balance between complexity and performance in learning-based image coding.

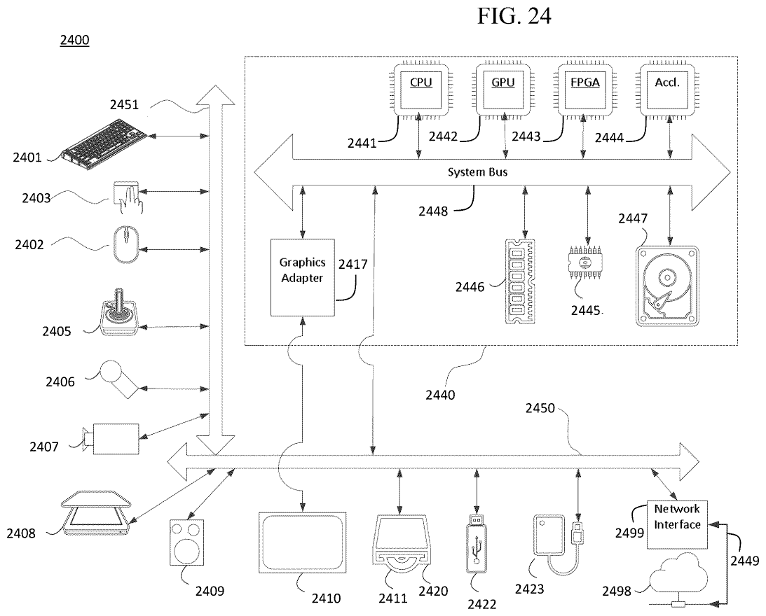

The techniques described above, can be implemented as computer software using computer-readable instructions and physically stored in one or more computer-readable media or by a specifically configured one or more hardware processors. For example, FIG. 24 shows a computer system 2400 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 24 for computer system 2400 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 2400.

Computer system 2400 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 2401, mouse 2402, trackpad 2403, touch screen 2410, joystick 2405, microphone 2406, scanner 2408, camera 2407.

Computer system 2400 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 2410, or joystick 2405, but there can also be tactile feedback devices that do not serve as input devices), audio output devices (such as: speakers 2409, headphones (not depicted)), visual output devices (such as screens 2410 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 2400 can also include human accessible storage devices and their associated media such as optical media including CD/DVD ROM/RW 2420 with CD/DVD 2411 or the like media, thumb-drive 2422, removable hard drive or solid state drive 2423, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 2400 can also include interface 2499 to one or more communication networks 2498. Networks 2498 can for example be wireless, wireline, optical. Networks 2498 can further be local, wide-area, metropolitan, vehicular and industrial, real-time, delay-tolerant, and so on. Examples of networks 2498 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 2498 commonly require external network interface adapters that attached to certain general-purpose data ports or peripheral buses (2450 and 2451) (such as, for example USB ports of the computer system 2400; others are commonly integrated into the core of the computer system 2400 by attachment to a system bus as described below (for example Ethernet interface into a PC computer system or cellular network interface into a smartphone computer system). Using any of these networks 2498, computer system 2400 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 2440 of the computer system 2400.

The core 2440 can include one or more Central Processing Units (CPU) 2441, Graphics Processing Units (GPU) 2442, a graphics adapter 2417, specialized programmable processing units in the form of Field Programmable Gate Areas (FPGA) 2443, hardware accelerators for certain tasks 2444, and so forth. These devices, along with Read-only memory (ROM) 2445, Random-access memory 2446, internal mass storage such as internal non-user accessible hard drives, SSDs, and the like 2447, may be connected through a system bus 2448. In some computer systems, the system bus 2448 can be accessible in the form of one or more physical plugs to enable extensions by additional CPUs, GPU, and the like. The peripheral devices can be attached either directly to the core's system bus 2448, or through a peripheral bus 2449. Architectures for a peripheral bus include PCI, USB, and the like.

CPUs 2441, GPUs 2442, FPGAs 2443, and accelerators 2444 can execute certain instructions that, in combination, can make up the aforementioned computer code. That computer code can be stored in ROM 2445 or RAM 2446. Transitional data can be also be stored in RAM 2446, whereas permanent data can be stored for example, in the internal mass storage 2447. Fast storage and retrieval to any of the memory devices can be enabled through the use of cache memory, that can be closely associated with one or more CPU 2441, GPU 2442, mass storage 2447, ROM 2445, RAM 2446, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 2400, and specifically the core 2440 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 2440 that are of non-transitory nature, such as core-internal mass storage 2447 or ROM 2445. The software implementing various embodiments of the present disclosure can be stored in such devices and executed by core 2440. A computer-readable medium can include one or more memory devices or chips, according to particular needs. The software can cause the core 2440 and specifically the processors therein (including CPU, GPU, FPGA, and the like) to execute particular processes or particular parts of particular processes described herein, including defining data structures stored in RAM 2446 and modifying such data structures according to the processes defined by the software. In addition or as an alternative, the computer system can provide functionality as a result of logic hardwired or otherwise embodied in a circuit (for example: accelerator 2444), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding performed by at least one processor, the method comprising:
receiving a video bitstream comprising a current block in a current picture; and
reconstructing the current block by transforming the current block by a neural network comprising a plurality of upsample modules and activation modules,
wherein at least one of the upsample modules comprises of a convolution layer and a pixel shuffle layer, and
wherein at least one of the activation modules comprises a LeakyReLu function and a convolution function.

2. The method according to claim 1, wherein the at least one of the upsample modules consists of the convolution layer and the pixel shuffle layer.

3. The method according to claim 1, wherein the at least one of the activation modules comprises a plurality of the LeakyReLu functions such that an output of the LeakyRelu function is output to the convolution function and an output of the convolution function is output to a second LeakyReLu function of the plurality of LeakyReLu functions.

4. The method according to claim 1, wherein an output of the LeakyRelu function is output to the convolution function and an output of the convolution function is output to a multiplication function.

5. The method according to claim 4, wherein an output of the multiplication function is output to an addition function.

6. The method according to claim 1, wherein an output of the LeakyRelu function is output to the convolution function and an output of the convolution function is output to an addition function.

7. The method according to claim 1, wherein the convolution function comprises a 1×1 filter.

8. The method according to claim 1, wherein each of the plurality of upsample modules comprises respectively different numbers of kilo multiply and accumulate (KMAC) operations.

9. The method according to claim 8, wherein one of the plurality of upsample modules comprises more than double a number of KMAC operations than does any of the other of the plurality of upsample modules.

10. The method according to claim 8, wherein the plurality of upsample modules consists of four upsample modules.

11. An apparatus comprising:
at least one memory configured to store computer program code;
at least one processor configured to access the computer program code and operate as instructed by the computer program code, the computer program code including:
receiving code configured to cause the at least one processor to receive a video bitstream comprising a current block in a current picture; and
reconstructing code configured to cause the at least one processor to reconstruct the current block by transforming the current block by a neural network comprising a plurality of upsample modules and activation modules,
wherein at least one of the upsample modules comprises of a convolution layer and a pixel shuffle layer, and
wherein at least one of the activation modules comprises a LeakyReLu function and a convolution function.

12. The apparatus according to claim 11, wherein the at least one of the upsample modules consists of the convolution layer and the pixel shuffle layer.

13. The apparatus according to claim 11, wherein the at least one of the activation modules comprises a plurality of the LeakyReLu functions such that an output of the LeakyRelu function is output to the convolution function and an output of the convolution function is output to a second LeakyReLu function of the plurality of LeakyReLu functions.

14. The apparatus according to claim 11, wherein an output of the LeakyRelu function is output to the convolution function and an output of the convolution function is output to a multiplication function.

15. The apparatus according to claim 14, wherein an output of the multiplication function is output to an addition function.

16. The apparatus according to claim 11, wherein an output of the LeakyRelu function is output to the convolution function and an output of the convolution function is output to an addition function.

17. The apparatus according to claim 11, wherein the convolution function comprises a 1×1 filter.

18. The apparatus according to claim 11, wherein each of the plurality of upsample modules comprises respectively different numbers of kilo multiply and accumulate (KMAC) operations.

19. The apparatus according to claim 18, wherein one of the plurality of upsample modules comprises more than double a number of KMAC operations than does any of the other of the plurality of upsample modules.

20. A non-transitory computer readable medium storing a program causing a computer to:
receive a video bitstream comprising a current block in a current picture; and
reconstruct the current block by transforming the current block by a neural network comprising a plurality of upsample modules and activation modules,
wherein at least one of the upsample modules comprises of a convolution layer and a pixel shuffle layer, and
wherein at least one of the activation modules comprises a LeakyReLu function and a convolution function.
